(19) United States
(12) Patent Application Publication
(10) Pub. No.: US 2026/0320236 A1
(43) Pub. Date: Oct. 15, 2026

(54) PHYSICAL UNCLONABLE FUNCTION SYSTEM AND MANUFACTURING METHOD FOR PHYSICAL UNCLONABLE FUNCTION DEVICE

(71) Applicant: HON HAI PRECISION INDUSTRY CO., LTD., New Taipei City (TW)

(72) Inventor: Min-Cheng CHEN, Hsinchu City (TW)

(21) Appl. No.: 19/239,926

(22) Filed: Jun. 16, 2025

(30) Foreign Application Priority Data
Apr. 10, 2025 (TW) 114113463

(51) Int. Cl. G06F 21/73

(52) U.S. Cl. CPC G06F 21/73

(57) ABSTRACT

A system of a physically unclonable function includes a logic circuit, and a physically unclonable function device. The physically unclonable function device includes a substrate, a via layer, and a pattern layer. The substrate includes at least one transistor. The via layer includes vias, in which the vias are disposed on the at least one transistor and arranged in an array. The pattern layer is disposed on the via layer and includes at least one conductive area. First vias of the vias overlap the at least one conductive area, and the first vias output signals from the transistor to the logic circuit through the conductive area.

### CROSS-REFERENCE TO RELATED APPLICATION

This application claims priority to Taiwan Application Serial Number 114113463, filed Apr. 10, 2025, which is herein incorporated by reference in its entirety.

### BACKGROUND

### Field of Invention

The present disclosure relates to a system of the physically unclonable function, and in particular to the system of the physically unclonable function in which a physical unclonable function device outputs signals from a transistor through a two-dimensional material.

### Description of Related Art

Like human beings, each integrated circuit (IC) chip has fingerprints generated during the manufacturing process. This intrinsic property can be extracted by adding a specific circuit structure, known as a physically unclonable function (PUF) device, to the IC chip.

Since the signal output from the PUF device is an analog signal, additional hardware is required to convert the analog signal into a signal that can be certified by the system. This increases the cost of manufacturing hardware. Therefore, how to provide physically non-replicable function devices to solve the above problem is an important issue in this field.

### SUMMARY

A system of the physically unclonable function includes a logic circuit and a physical unclonable function device. The physical unclonable function device includes a substrate, a via layer, and a pattern layer. The substrate includes at least one transistor. The via layer includes vias, in which the vias are disposed on the transistor, and the vias are arranged in the array. The pattern area is disposed on the via layer and includes at least one conductive area. First vias of the via overlap the conductive area, and the first vias output at least one signal from the at least one transistor to the logic circuit through the at least one conductive area.

A method of manufacturing the physical unclonable function device, includes: forming a via array in a first layer; and forming at least one conductive area in a second layer over the first layer, in which the conductive area covers and is coupled to a first portion of the via array, and the at least one conductive area is separated from a second portion of the via array.

### BRIEF DESCRIPTION OF THE DRAWINGS

For making the foregoing and other purposes, features, advantages, and embodiments of the present disclosure more readily apparent, the accompanying drawings are illustrated as follows:

FIG. 1 illustrates a schematic diagram of a physical unclonable function device, in accordance with one embodiment of the present disclosure.

FIG. 2 illustrates a flow chart of a method for manufacturing the physical unclonable function device of FIG. 1, in accordance with one embodiment of the present disclosure.

FIG. 3 illustrates a top view diagram of the physical unclonable function device of FIG. 1, in accordance with one embodiment of the present disclosure.

FIG. 4A illustrates a cross-section view diagram of the physical unclonable function device along a line AA′ of FIG. 3, in accordance with one embodiment of the present disclosure.

FIG. 4B illustrates a cross-section view diagram of the physical unclonable function device along the line AA′ of FIG. 3, in accordance with the other embodiment of the present disclosure.

FIG. 5 illustrates a system 500 of the physically unclonable function, in accordance with one embodiment of the present disclosure.

FIG. 6 illustrates a schematic diagram of the physical unclonable function device 100, in accordance with one embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

As used herein, the terms “comprising,” “including,” “having,” “containing,” “involving,” and the like are to be understood to be open-ended, i.e., to mean including but not limited to.

Reference throughout the specification to “one embodiment,” “an embodiment,” or “some embodiments” means that a particular feature, structure, implementation, or characteristic described in connection with the embodiment(s) is included in at least one embodiment of the present disclosure. Thus, uses of the phrases “in one embodiment” or “in an embodiment” or “in some embodiments” in various places throughout the specification are not necessarily all referring to the same embodiment. Furthermore, the particular features, structures, implementation, or characteristics may be combined in any suitable manner in one or more embodiments.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. As used herein, the term “and/or” includes any and all combinations of one or more of the associated listed items.

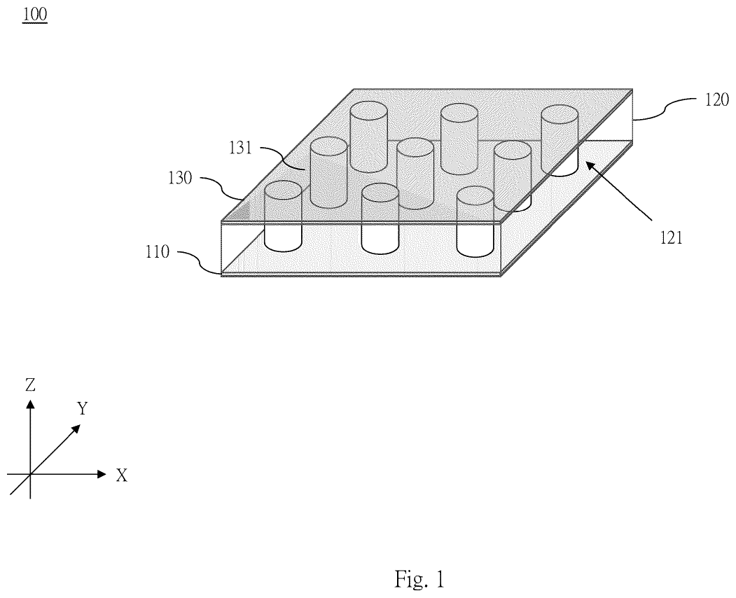

Please refer FIG. 1. FIG. 1 illustrates a schematic diagram of a physical unclonable function device 100, in accordance with one embodiment of the present disclosure. As shown in FIG. 1, the physical unclonable function device 100 includes a substrate 110, a via layer 120, and a pattern layer 130. The via layer 120 includes vias 121. The pattern layer 130 includes a conductive area 131.

In some embodiments, the substrate 110 is a pure silicon structure. In various embodiments, the substrate 110 includes semiconductors of other elements, such as germanium. The substrate 110 includes compound semiconductor, such as silicon carbide, gallium arsenide, indium arsenide, and indium phosphide. The various embodiments of the substrate 110 are included in expected scope of the present disclosure. For example, in some embodiments, the substrate 110 includes alloy semiconductors, such as silicon germanium, silicon germanium carbide, gallium arsenide phosphide, and indium gallium phosphide.

In some embodiments, the via 121 includes metal materials. For example, the via 121 includes gold, silver, copper, or other metal materials. The various embodiments of the via 121 are included in expected scope of the present disclosure. For example, in some embodiments, the via 121 includes steel, stainless steel, carbon steel, or other similar alloys.

In some embodiments, the conductive area 131 included in the pattern layer 130 includes a two-dimensional material. For example, the conductive area 131 includes molybdenum disulfide (MoS₂), tungsten disulfide (WS₂), tungsten diselenide (WSe₂), graphene, other similar two-dimensional materials, or combinations thereof.

In some embodiments, the pattern layer 130 further includes a dielectric material or/and an insulator material in addition to the two-dimensional material. For example, the pattern layer 130 further includes silicon dioxide or other similar insulator materials.

In some embodiments, the conductive area 131 is randomly distributed in the pattern layer 130. For example, a formation process of the conductive area 131 is not fully controllable and predictable, but is formed in the pattern layer 130 with statistical uncertainty. In some embodiments, in a system including the multiple physical unclonable function devices 100, the conductive areas 131 are not duplicated in the pattern layer 130.

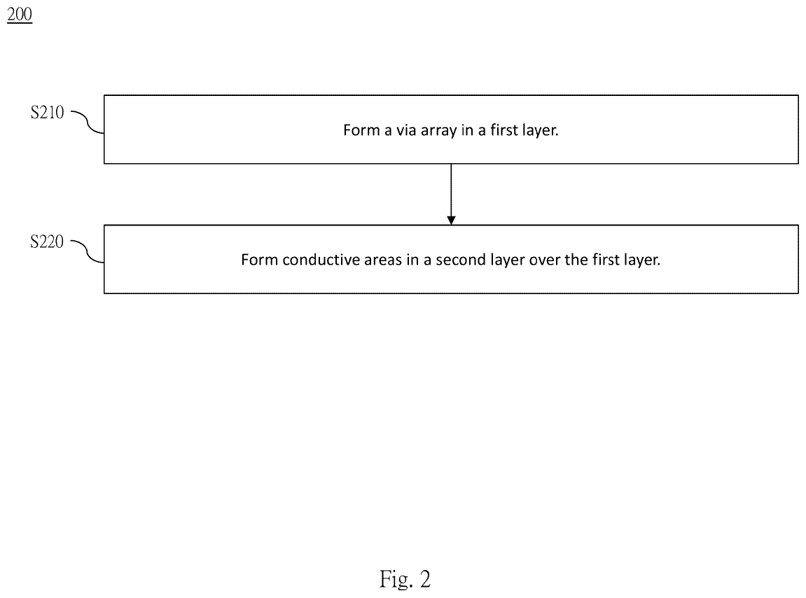

Please refer FIG. 2. FIG. 2 illustrates a flow chart of a method 200 for manufacturing the physical unclonable function device 100 of FIG. 1, in accordance with one embodiment of the present disclosure.

According to OPERATION S210, a via array is formed in the via layer 120.

For example, the via array of the via layer 120 is formed by an existing semiconductor back-end damascene flattening copper process or other similar customary metal via methods.

According to operation S220, the conductive area 131 is formed in the pattern layer 130 over the via layer 120.

For example, a deposition tool forms the conductive area 131 including the MoS₂ in the pattern layer 130 by metal-organic chemical vapor deposition (MOCVD). The conductive area 131 in the pattern layer 130 is formed by the MOCVD, tape transfer, physical vapor deposition (PVD), chemical vapor deposition (CVD), electrochemical deposition (ECD), filling, or formed by other similar methods.

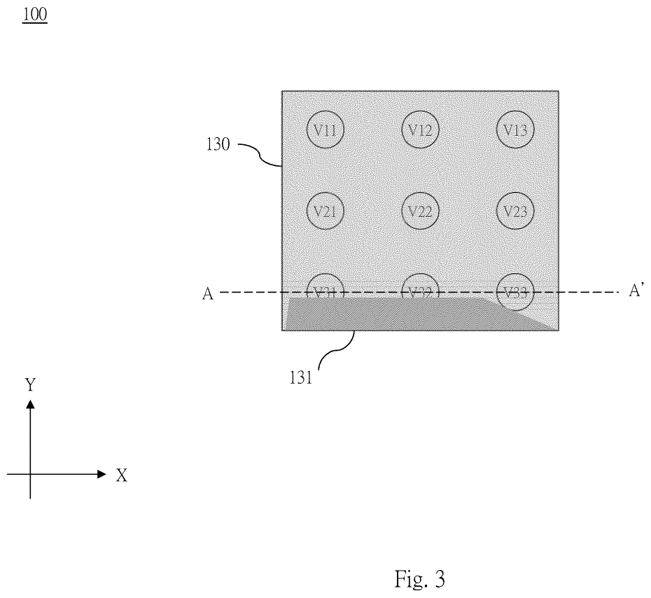

Please refer FIG. 3. FIG. 3 illustrates a top view diagram of the physical unclonable function device 100 of FIG. 1, in accordance with one embodiment of the present disclosure. For ease of understanding, corresponding the embodiment of FIG. 1, the same components of FIG. 3 are indicated by the same symbols. In some embodiments, multiple vias V11 to V33 shown in FIG. 3 can correspond to the multiple vias 121 shown in FIG. 1.

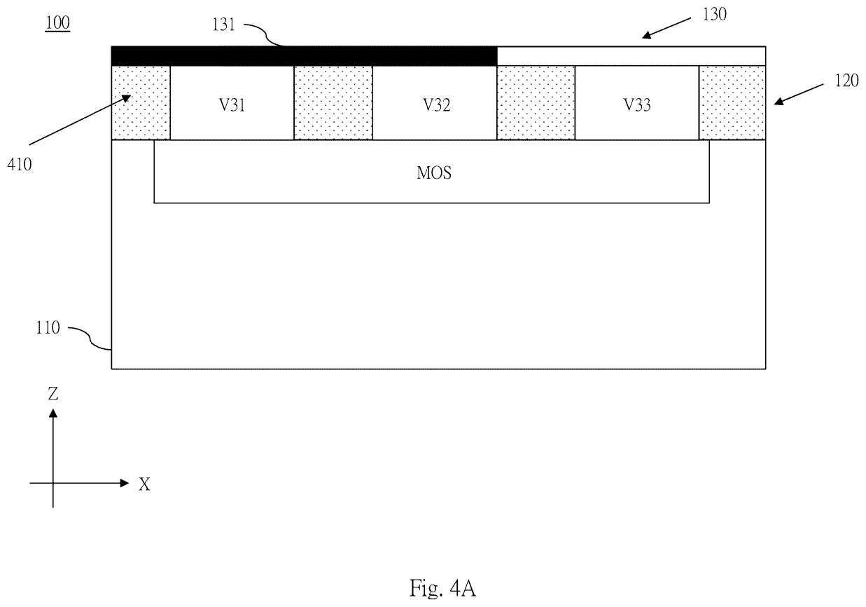

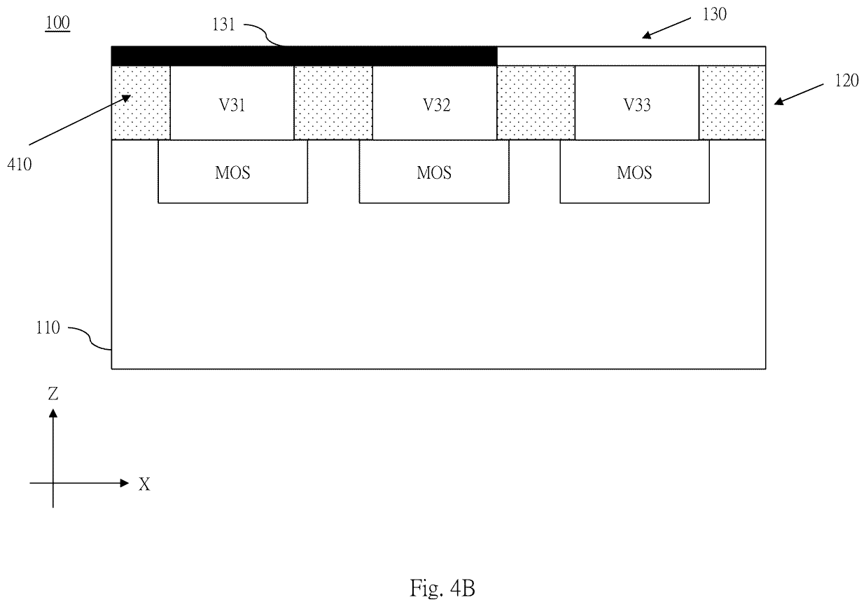

Please refer FIG. 4A. FIG. 4A illustrates a cross-section view diagram of the physical unclonable function device 100 along a line AA′ of FIG. 3, in accordance with one embodiment of the present disclosure.

In structure relationship, the pattern layer 130 is disposed on the via layer 120, and the via layer 120 is disposed on the substrate 110. The via layer 120 includes the vias V31 to V33 and the dielectric layer 410. The substrate 110 includes a transistor MOS. The vias V31 to V33 are arranged in an array on the substrate 110.

In some embodiments, the dielectric layer 410 is silicon dioxide (SiO₂), silicon oxynitride (SiON), other similar dielectric materials, or combinations thereof.

In some embodiments, the transistor MOS is a metal oxide semiconductor field effect transistors (MOSFET) or other similar components.

In some embodiments, the vias V31 to V33 are disposed on the transistor MOS. For example, the vias V31 to V33 are disposed on one transistor MOS. In some embodiments, the vias V31 to V33 are on one terminal of the transistor MOS (e.g., a drain terminal or a source terminal).

Please refer FIG. 4B. FIG. 4B illustrates a cross-section view diagram of the physical unclonable function device 100 along a line AA′ of FIG. 3, in accordance with the other embodiment of the present disclosure. Unless there is a need to illustrate a synergy of the elements, specific operations of similar elements, steps discussed, the specific operations of similar elements, which are already discussed in detail in above paragraphs, are omitted herein for the sake of brevity.

In some embodiments, the vias V31 to V33 are disposed on the multiple transistors MOS. For example, the vias V31 to V33 are disposed on 3 transistors MOS respectively.

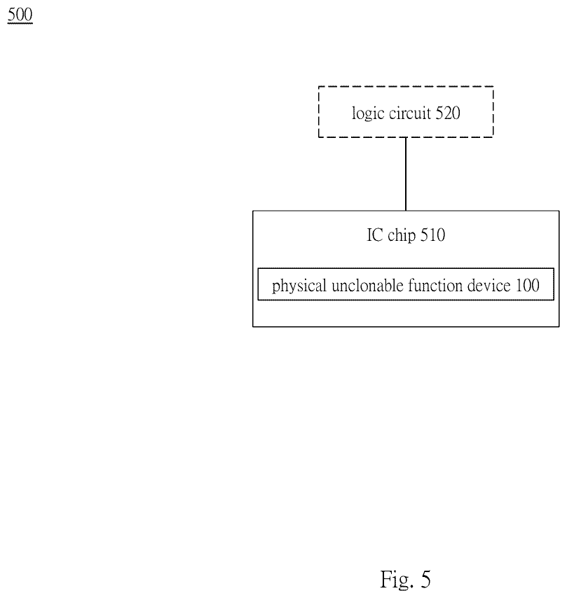

Please refer FIG. 5. FIG. 5 illustrates a system 500 of the physically unclonable function, in accordance with one embodiment of the present disclosure.

In connection relationship, an integrated circuit (IC) chip 510 includes the physical unclonable function device 100, and the IC chip 510 is coupled to a logic circuit 520. In some embodiments, the IC chip 510 [symbol] the logic circuit 520.

Please refer FIG. 3, FIG. 4A, FIG. 4B, and FIG. 5 together. In some embodiments, the conductive area 131 overlaps the vias V31 and V32 to make the vias V31 and V32 output multiple signals from the transistor MOS to the logic circuit 520 through the conductive area 131.

Please refer FIG. 3, FIG. 4A, FIG. 4B, and FIG. 5 together. in some embodiments, the conductive area 131 is separated from the via V33 to make the via V33 electrically separated from the conductive area 131. In other words, the conductive area 131 will not output a signal from the via V33.

In some embodiments, the logic circuit 520 generates a coded signal based on signals from the physical unclonable function device 100.

According to the above embodiments, the coded signal corresponds to a plurality of bits, and a number of the bits is related to a number of the vias 121. For example, the physical unclonable function device 100 includes 9 vias V11 to V33, and adjacent vias correspond to 1 bit. For example, the physical unclonable function device 100 includes 9 vias V11 to V33, the vias V11 and V12 are adjacent, the vias V11 and V21 are adjacent, the vias V12 and V22 are adjacent, etc. Therefore, the coded signal corresponds to 12 bits.

In some embodiments, when the conductive area 131 overlaps the adjacent vias 121, i.e., when the adjacent vias 121 both output the at least one signal form the transistor MOS to the logic circuit 520, the logic circuit 520 determines that a bit value of the coded signal corresponding to the vias 121 is 1, or else the bit value is 0. Please refer FIG. 3 and FIG. 5. For example, because the conductive area 131 overlaps the vias V31 and V32, the logic circuit 520 determines that a bit value of the vias V31 and V32 is 1. Because the conductive area 131 overlaps the via V32, but separated from the via V33, the logic circuit 520 determines a bit value of the vias V32 and V33 is 0. Because the conductive area 131 is separated from the vias V23 and V33, the logic circuit 520 determines that a bit value of the vias V32 and V23 is 0.

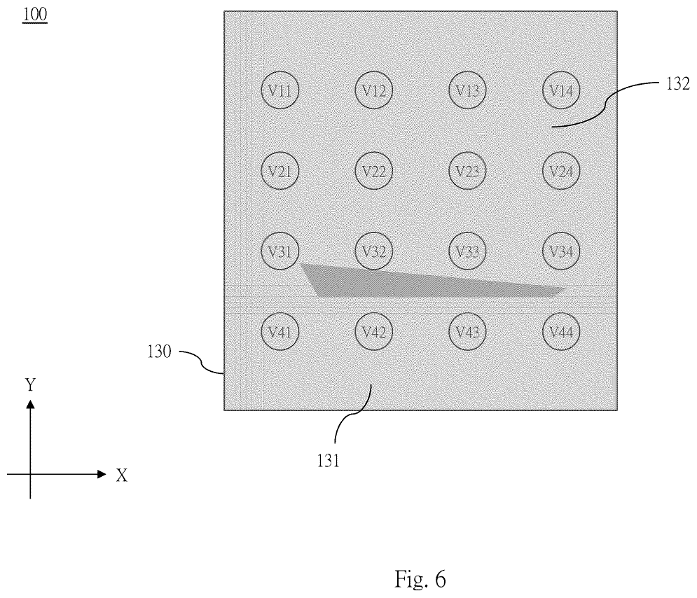

Please refer FIG. 5 and FIG. 6. FIG. 6 illustrates a schematic diagram of the physical unclonable function device 100, in accordance with one embodiment of the present disclosure. In some embodiments, by logic gates determining whether the adjacent vias 121 output signals from the transistor MOS, the logic circuit 520 determines the bit values between the corresponding adjacent vias 121. For example, because the conductive area 131 overlaps the vias V42 and V43, the logic circuit 520 receives signals outputted from vias V42 and V43 through an input terminal of an AND gate. At this time, bit values of the input terminal corresponding to the vias V42 and V43 are both 1, so an output terminal of the AND gate outputs the bit value corresponding to the vias V42 and V43 as 1. Because the conductive area 131 overlaps the via V43, but separated from the via V33, the logic circuit 520 receives signals outputted from vias V43 and V33 through the input terminal of the AND gate. At this time, bit values of the input terminal corresponding to the vias V43 and V33 are 1, 0 respectively, so output terminal of the AND gate outputs the bit value corresponding to the vias V43 and V33 as 0. Because the conductive area 131 is separated from the vias V32 and V33, the logic circuit 520 receives signals outputted from vias V32 and V33 through the input terminal of the AND gate. At this time, the output terminal of the AND gate outputs the bit value corresponding to the vias V32 and V33 as 0.

In some embodiments, the logic circuit 520 generates the coded signal based on the signals, in which the logic circuit 520 arranges the bits of the corresponding coded signal between the adjacent vias 121. For example, please refer FIG. 3, the vias V11 to V33 can generate the coded signal having 12 bits. The logic circuit 520 can arrange a first bit of the corresponding the coded signal between the vias V11 and V12, a second bit of the corresponding the coded signal the vias V12 and V13, . . . a eleventh bit of the corresponding the coded signal the vias V31 and V32, and a twelfth bit of the corresponding the coded signal the vias V32 and V33, so the coded signal generated by the logic circuit 520 is 010000000000.

In some embodiments, the number of the vias 121 of the physical unclonable function device 100 can be any positive integer. For example, as shown in FIG. 6, the physical unclonable function device 100 includes 16 vias V11 to V44.

In some embodiments, the physical unclonable function device 100 includes more than 1 conductive area 131. For example, as shown in FIG. 6, the physical unclonable function device 100 includes 2 conductive areas 131 and 132. The conductive area 131 overlaps the vias V42 and V43, the conductive area 132 overlaps the vias V13, V14, and V23, and other vias are separated from the conductive areas 131 or 132. At this time, the logic circuit 520 generates the coded signal 010000000000000000100100, in which the coded signal having 24 bits.

In some embodiments, the coded signal corresponding to the multiple bits, the number of the bits is positively correlated with the number of the vias 121. For example, as shown in FIG. 3, the physical unclonable function device 100 includes 9 vias V11 to V33, so the logic circuit 520 generates the coded signal having 12 bits. As shown in FIG. 6, the physical unclonable function device 100 increases 16 vias V11 to V44, so the logic circuit 520 generates the coded signal having 16 bits.

In some embodiments, the conductive areas 131 and 132 are arbitrarily shaped. For example, the conductive areas 131 and 132 may be triangular, square, hexagonal, or other shapes.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system of a physically unclonable function, comprising:
a logic circuit; and
a physical unclonable function device, comprising:
a substrate and at least one transistor disposed on the substrate; and
a via layer, comprising:
a plurality of vias, wherein the plurality of vias are disposed on the at least one transistor, and the plurality of vias are arranged in an array; and
a pattern layer disposed on the via layer, comprising:
at least one conductive area;
wherein, a plurality of first vias in the plurality of vias overlap the at least one conductive area, and the plurality of first vias output at least one signal from the at least one transistor to the logic circuit through the at least one conductive area.

2. The system of claim 1, wherein the plurality of vias are disposed on at least one source/drain terminal of the at least one transistor.

3. The system of claim 1, wherein a plurality of second vias in the plurality of vias are separated from the at least one conductive area.

4. The system of claim 1, wherein the at least one transistor includes a plurality of transistors, and each of the plurality of transistors is coupled to a corresponding one of the plurality of vias.

5. The system of claim 4, wherein the corresponding one of the plurality of vias is disposed on a source/drain terminal of a corresponding one in the plurality of transistors.

6. The system of claim 1, wherein the logic circuit is configured to generate a coded signal based on the at least one signal.

7. The system of claim 6, wherein the coded signal corresponds to a plurality of bits, and a number of the plurality of bits is positively correlated with a number of the plurality of vias.

8. The system of claim 7, wherein when adjacent ones of the plurality of first vias both output the at least one signal from the at least one transistor to the logic circuit, the logic circuit generates a first portion, of the plurality of bits, having a bit value 1, wherein the first portion of the plurality of bits correspond to the adjacent ones of the plurality of first vias.

9. The system of claim 8, wherein when a plurality of second vias of the plurality of vias are separated from the at least one conductive area the logic circuit generates a second portion of the plurality of bits, having a bit value 0, wherein the second portion of the plurality of bits correspond to the plurality of second vias.

10. The system of claim 7, wherein the logic circuit comprises at least one logic gate, wherein the at least one logic gate is configured to determine bit values of the plurality of bits based on whether the plurality of vias output the at least one signal.

11. The system of claim 1, wherein the pattern layer includes a two-dimensional material.

12. The system of claim 11, wherein the two-dimensional material includes one of molybdenum disulfide (MoS₂), tungsten disulfide (WS₂), and tungsten diselenide (WSe₂).

13. The system of claim 1, wherein the at least one conductive area is a triangular, a square, or a hexagonal.

14. A method of manufacturing a physical unclonable function device, comprising:
forming a via array in a first layer; and
forming at least one conductive area in a second layer over the first layer, wherein the at least one conductive area covers and is coupled to a first portion of the via array, and the at least one conductive area is separated from a second portion of the via array.

15. The method of claim 14, wherein forming the via array comprising:
forming the via array by semiconductor back-end damascene flattening copper process.

16. The method of claim 14, wherein forming the conductive area comprises:
forming the conductive area by metal-organic chemical vapor deposition (MOCVD).

17. The method of claim 14, wherein forming the conductive area comprises:
forming the conductive area by tape transfer.

18. The method of claim 14, wherein forming the conductive area comprises:
forming the conductive area by electrochemical deposition.

19. The method of claim 14, wherein the at least one conductive area is randomly distributed in the second layer.

20. The method of claim 14, wherein the at least one conductive area includes one of molybdenum disulfide (MoS₂), tungsten disulfide (WS₂), and tungsten diselenide (WSe₂).
